(19) United States
(12) Patent Application Publication
(10) Pub. No.: US 2006/0037079 A1
(43) Pub. Date: Feb. 16, 2006

(54) System, method and program for scanning for viruses

(75) Inventor: Nicholas James Midgley, Waterlooville (GB)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 11/196,008

(22) Filed: Aug. 2, 2005

(30) Foreign Application Priority Data
Aug. 13, 2004 (GB) 0418066.7

(51) Int. Cl. G06F 12/14

(52) U.S. Cl. 726/24

(57) ABSTRACT

System, method and program product for scanning files for a virus. A multiplicity of files which have been accessed since a previous virus scan are identified. Based on the identifications of the multiplicity of files which have been accessed since a previous virus scan, the multiplicity of files are scanned for viruses. Other files which have not been accessed since the previous virus scan are not scanned for viruses. The scanning can be limited to those files which have been updated since the previous virus scan. The scanning of the multiplicity of files for viruses can be performed by scanning the multiplicity of files in a priority order. The priority order can be based on a type of extension of the multiplicity of files or an elapsed time since the files of the multiplicity were accessed and not scanned for viruses.

### FIELD OF THE INVENTION

The invention relates generally to computers, and more specifically to scanning for viruses.

### BACKGROUND OF THE INVENTION

Virus detection software is currently known to identify and erase any computer files containing a computer virus. Virus scanning requires examination of most if not all computer files stored in the computer's file system. Typically, the virus detection software conducts a key word-type search of the files for lines of code or sequences of commands characteristic of the virus. Such lines of code or sequences of commands are sometimes called the “signature” of the virus.

Typically, there are many files on a computer's hard disk drive, and it can take considerable time to scan them all for viruses. Also, a user's computer files may be stored on disk drives located across a network. In such a case, the network storage devices will also need to be scanned for viruses. The virus scan consumes much of the processor's time and slows system performance.

Therefore, an object of the present invention is to expedite the virus scan.

### SUMMARY OF THE INVENTION

The present invention resides in a system, method and program product for scanning files for a virus. A multiplicity of files which have been accessed since a previous virus scan are identified. Based on the identifications of the multiplicity of files which have been accessed since a previous virus scan, the multiplicity of files are scanned for viruses. Other files which have not been accessed since the previous virus scan are not scanned for viruses.

According to a feature of the present invention, the scanning can be limited to those files which have been updated since the previous virus scan.

According to another feature of the present invention, the scanning of the multiplicity of files for viruses is performed by scanning the multiplicity of files in a priority order. The priority order is based on a type of extension of the multiplicity of files. For example, an .exe type of file may have higher priority than files with other types of extensions.

According to another feature of the present invention, the scanning of the multiplicity of files for viruses is performed by scanning the multiplicity of files in a priority order. The priority order is based on a duration of an elapsed time since the files of the multiplicity were accessed and not scanned for viruses.

According to another feature of the present invention, the scanning of the multiplicity of files for viruses is performed by scanning the multiplicity of files in a priority order. The priority order is based on whether the files of the multiplicity were scanned for viruses during a previous scan cycle.

### BRIEF DESCRIPTION OF THE DRAWINGS

FIG. 1 illustrates a data processing system in which the invention may be embodied.

FIG. 2 illustrates the components of an operating system and how the components interact with the hardware installed on the data processing system of FIG. 1.

FIG. 3 illustrates the components of the prioritization logging component of the invention.

FIG. 4 illustrates the operational steps of the invention when operational for the first time.

FIG. 5 illustrates the interception and capturing of operations made to the file system structure by a subsequent application.

FIG. 6 illustrates the initialization of the file system map engine of FIG. 3.

FIG. 7 illustrates the operational running steps of the file system map engine of FIG. 3.

FIG. 8 illustrates the operational steps of the file system map engine of FIG. 3 during the scanning process.

FIG. 9 illustrates the process steps of the difference engine of FIG. 3.

FIG. 10 shows the operational steps of the invention during a scanning cycle.

### DETAILED DESCRIPTION OF THE PREFERRED EMBODIMENTS OF THE INVENTION

To aid the reader's understanding of some of the terms used throughout the Detailed Description, a brief overview of some these terms is given.

A file system structure comprises a collection of files of data and a directory structure which organizes and provides information about all the files located within the file system structure. The file system structure also comprises clusters on which a file's data is stored on the hard disk drive.

A sector is the smallest physical storage unit on a disk drive. Typically a sector is 512 bytes in size. Each disk sector is labeled using a factory track-positioning data system. Sector identification data is written to the designated sector area immediately before the contents of the sector is written and identifies the starting address of the cluster. A file is stored on the disk drive in a contiguous series. Because most files are larger than 512 bytes, the operating system typically allocates more than one sector to store the file's data. For example, if the file size is 800 bytes, the operating system allocates two 512 byte sectors for the file.

The fundamental storage unit of a file system is a cluster. A cluster is a group of sectors. This allows the file system to optimize the administration of disk data independently of the disk sector size set by the hardware disk controller. If the disk to be administered is large, and large amounts of data are moved and organized in a single operation, the administrator can adjust the cluster size to accommodate this.

Partitions or volumes allow physical or logical separation of large collections of directories into separate storage areas on a single disk drive. Each partition may be treated as a separate storage device or, in some types of systems, partitions may be larger than a disk drive to group disk drives into one logical structure.

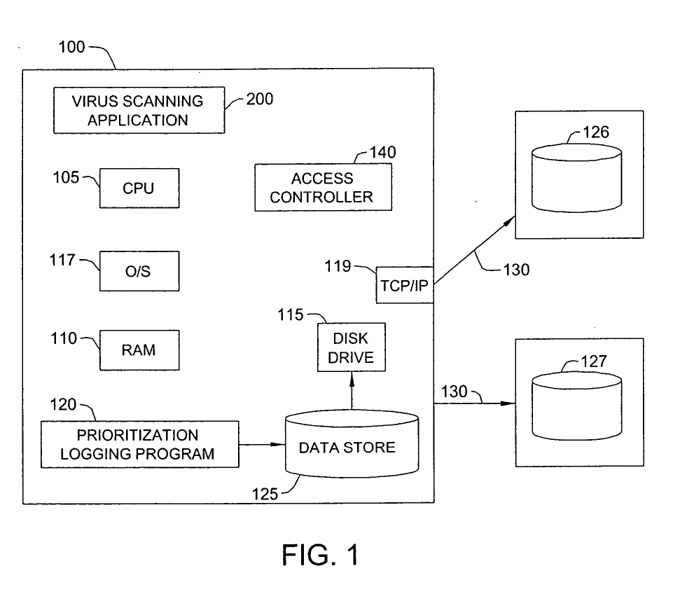

FIG. 1 illustrates a number of components of a data processing system 100, including a data store 125 residing on a local disk drive 115, a central processing unit (CPU) 105, Random Access Memory (RAM) 110 and a Motherboard with a hard disk access controller 140. Other components may comprise a graphic card, sound card and a network access device etc (not shown). The storage capacity of the data processing system 100 may be extended by accessing a number of networked storage devices 126 and 127 over a network 130, such as an Intranet or the Internet, or alternatively a number of local ‘add on’ storage devices (not shown).

The data processing system 100 is running a prioritization logging program 120 for use with a virus scanning application 200. As is known in the art, a virus scanning application 200 executes a virus scanning engine in RAM 110. The virus scanning engine identifies data, files, directories or clusters to be checked for the presence of known viruses. Application 200 performs the check by cross matching identified attributes of data with attributes or signature of a virus in a virus definition file. If an element of data is identified as containing a virus, the identified data is quarantined and deleted.

The prioritization logging program 120 may be implemented as a stand-alone program or may be hard coded into the virus scanning application 200 at the time of development. A stand-alone implementation may be implemented as an ‘add on’ module which may purchased over the counter or downloaded from a vendor's web site. The prioritization logging program 120 may be developed in any programming language and further provides the appropriate API's for interfacing with a number of virus scanning applications 200.

The prioritization logging program 120 cooperates with the virus scanning application 200 to identify to the virus scanning application 200 which files, directories or disk clusters should take priority in the scanning process the next time a scan cycle takes place.

The prioritization logging program 120 may monitor changes to files at various levels of granularity. For example, program 120 may monitor changes to a file i.e. a write operation to a file, and/or detect changes at the cluster level on the hard disk drive. As another example, program 120 may monitor an .exe files containing a virus embedded in a cluster of the hard disk drive which is determined to not be part of the identified file system. The level of granularity determines in part which files that need be scanned for viruses.

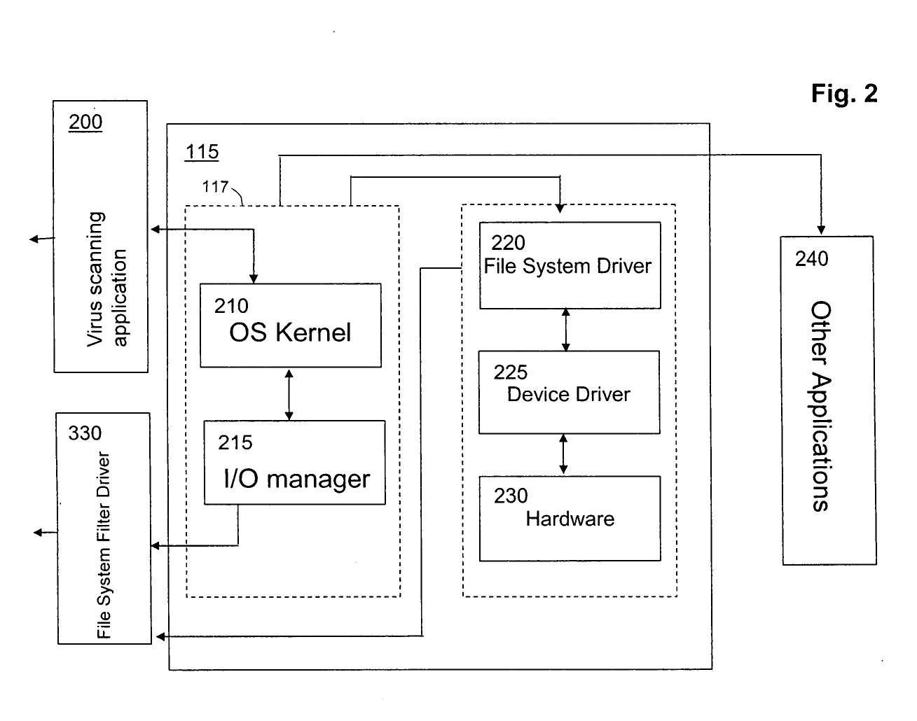

FIG. 2 illustrates how “low level” components of operating system 117 interact with virus scanning application 200. The virus scanning application 200 sends a request to the operating system's kernel 210, to carry out a virus scanning cycle. The operating system kernel 210 cooperates with I/O manager 215 to schedule tasks that have been requested to be carried out by the virus scanning application 200 and any other applications 240 wanting to execute a task. Each requested task will utilize a proportion of CPU resource, and the I/O manager 215 ensures that each request has some CPU resource allocated to carry out its task.

The basic hardware elements that are involved in input/output operations are buses, device controllers and the devices themselves. The software that controls a device is called a device driver 225. The device driver 225 presents a uniform device access interface to the I/O subsystem.

An example of FIG. 2 in use is as follows: An application 200, 240 makes a request to open a file; a system call in the operating system kernel 210 determines whether this function is possible. If a positive determination is made, the request is placed in a wait queue for the device that needs to be accessed, for example, the hard disk drive 125. A further request is sent to the file system driver 220, because the request is a file related services request. The file system driver 220 locates the device driver 225 that controls the hardware 230, for which access is required and sends a request to the device driver 225. The device driver 225 allocates kernel buffer space to receive the data and schedules the I/O. The device driver 225 operates the hardware 230 to perform the data transfer. In another embodiment, if the virus scanning application 200 is requesting access to a file or intercepting access to a file, the I/O manager 215 sends the requested information to the virus scanning application 200 via the file system filter driver 330.

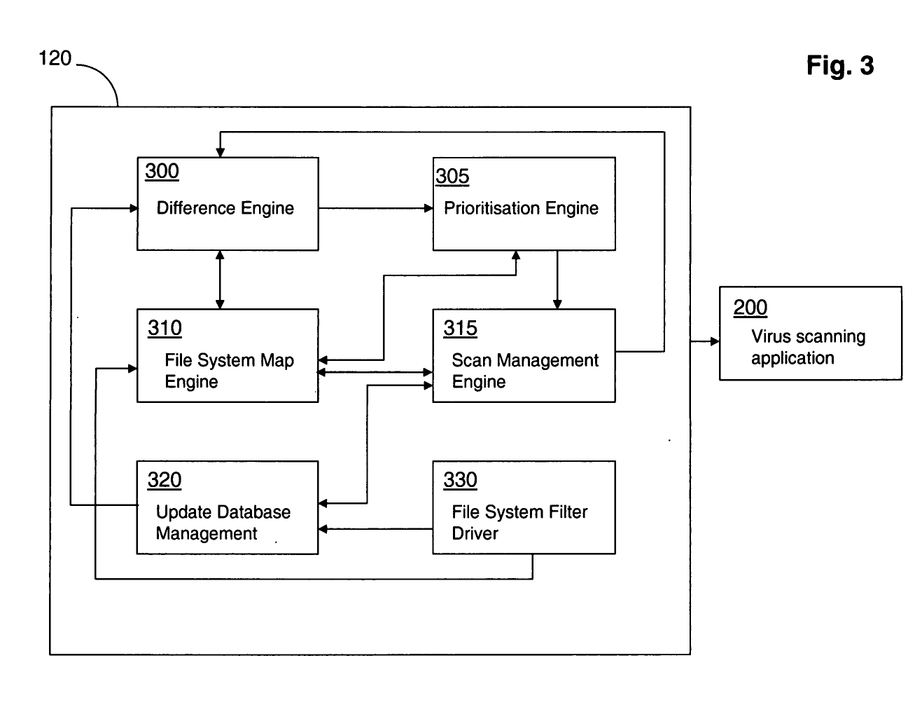

FIG. 3 illustrates the components of the prioritization logging program 120. Program 120 comprises a difference engine 300, a prioritization engine 305, a file system map engine 310, a scan management engine 315, an update database management program 320 and a file system filter driver program 330. The function of each of these components will now be explained in turn.

The file system map engine 310 creates and maintains a map of the file system structure as stored on the data processing system's 100 disk drive and/or one or more logical disk drive 115. The file system map engine 310 creates a map of the file system structure comprising the directories and/or files that are identified as making-up the file system structure. If it detected by the update management engine 320, that a cluster update was made to the file system structure and it is determined that the cluster update cannot be mapped to an associated computer file belonging to the file system structure, the file system map engine 310 creates a cluster map for storing data pertaining to the cluster update.

On initialization of the prioritization logging program 120 (i.e. when installed and functioning on the data processing system 100 for a first time) the file system map engine 310 takes a “snap shot” of the file structure. The disk drives for which the file system map engine 310 creates a file system representation may be modified by the user from a selectable menu function or by other means of providing modification of functionality to the user.

If at any time the file system map engine 310 detects that one of the file system maps (file system map and the cluster map) is inaccessible, for example, the file system map is corrupted, the file system map engine 310 may delete the corrupted file system map and create a new file system map. Alternatively, the file system map engine 310 may try and determine why the file system map is corrupted by analyzing a log of read/write operations to the file system structure.

The file system map(s) may be used for the following purposes:
1. Creating and recording updates/and or changes to the file system structure, for example, files, directories, clusters and partitions.
2. Recording of directories, files and clusters which were not scanned during a previous virus scan cycle. This may happen because the virus scanning application 200 was terminated without completing the scan. Identification of the virus scanning application 200 terminating a scan may either be due to the scan management engine 315 losing communication with the virus scanning application 200 during a scan, indicating that the virus scanning application 200 was stopped, or through the checking of checkpoints created during the generation of the scan list by the prioritization engine 305. The file entries for directories, files and clusters which were not scanned during a previous scan cycle may be purged after a successful scan cycle has taken place in order to save on disk storage space and speed up data retrieval and access times by the other components of the prioritization logging program 120.
3. Recording a number of files per directory. This is used as input into the scan list and provides for the creation of check points within the scan list to enable the scan management engine to detect the scan cycle in which the virus scan application 200 terminated.

A checkpoint may take the form of a binary digit or a tag or other marker.

An example of a file system map, created by the file system map engine 310, may be as follows:

### EXAMPLE 1

Volume C
Volume serial number XYZ
Directory of C:\
<DIR> $user
<DIR> documents
<DIR> accounts
abc.log
def.txt
auto.exe

As can be seen from the foregoing example, the file system map comprises a number of identifiers which identify the name and serial number of the volume (or partition) followed by a list of directories and files residing within the identified directories. For example, volume C is the name of the particular volume in Example 1. However, a hard disk drive may comprise several volumes, for example, volume C and volume D. The volume serial number ‘XYZ’ is a unique identifier for the volume given by the application that formats the hard disk drive.

There are three directory entries in this example. <DIR> indicates to the operating system this is a directory entry: $user, documents and accounts being the names of each of the individual directory entries. Within each directory entry (<DIR>) there may be one or more files, or one or more other directory entries.

Many types of directory structures exist, the most common being a tree-structured directory. Other types of directory structures include a single level directory, a two level directory, an acyclic-graph directory and a general graph directory. The invention is operable for use with these and other directory structures as would be understood by a person skilled in the art.

The file system map may take the form of a text file, a set of records for use with a data base storage and/or retrieval mechanism, a graphical representation or any other data management mechanism which allows the storing of a representation of the file system structure.

On startup, the file system map engine 310 scans the file system to obtain the file system structure across all the designated partitions. This step may be performed sequentially or in parallel across all partitions. The file system map engine 310 calculates and stores the total number of files residing in each directory for the calculation of checkpoints. Once calculated the information is communicated to the scan management engine 315 for determining in which position to insert the checkpoints within the scan list. In addition, the file system map engine 310 manages a cluster map for recording direct cluster updates on the hard disk drive by applications bypassing the normal file I/O operations. The file system map engine 310 creates the cluster map at startup by, and populates the cluster map with information linking the cluster updates to the files identified as part of the file system structure on each volume. This enables future cross checking of clusters to files when direct cluster update requests are intercepted by the file system filter driver component 330.

When a cluster update is received, the file system management engine 310 checks to see if the update to a cluster is part of the file system structure by cross checking the cluster to which the update is being made, against the cluster map. If a positive determination is calculated, the file pertaining to the cluster update is recorded as requiring a scan. To explain further, if it is determined that the cluster numbered ‘123’ is currently being written, a lookup is performed within the file system map to determine if a file is already stored at cluster 123. If a positive determination is made, the file stored at cluster 123 is flagged as requiring a scan. Alternatively, if a negative determination is made, the cluster 123 is flagged as requiring a scan in the cluster map.

The file system map engine 310 updates the file system map(s) in response to a detected change in the file system structure, for example, the creation and/or deletion of a directory, a file or a cluster.

The file system map engine 310 is responsive to receiving information updates from the scan management engine 315, the file system filter driver component 330, the prioritization engine 305 and the difference engine 300 to continually update the file system map(s), such that, it is a true representation of the file system structure since the last scan cycle.

In order for changes to the file system structure to be detected, the file system filter driver component 330 intercepts each access to the file system structure made by the operating system or an application, for example, a write operation made to a file or a directory creation or deletion.

An intercept by the file system filter driver 330 is achieved by cooperating with an existing file system driver 220 within the operating system executing on the data processing system 100. For example, in one embodiment of the present invention, the data processing system 100 is implemented on a Microsoft Windows NT operating system. On receiving a request to access a file, a file access request is translated by the operating system into file input and output operations using discrete command packets called I/O request packets (IRPs). An IRP is generated by the operating system's file related services, such as, NtReadFile and NtCreateFile, for example.

When an application wishes to perform an operation on a file, a file related service is automatically invoked and an I/O Manager delivers the resulting IRPs to the file system driver responsible for managing the file (i.e. the file that the application wishes to access). As there may be multiple file systems present on the data processing system 100, or to which the data processing system 100 is attached, the I/O Manager locates the required file system driver through one of the driver's device objects that serves as a logical representation of the file on which the system driver resides. In this embodiment of the present invention, the Microsoft Windows NT operating system enables “filter drivers” to create device objects that attach to other device objects. The I/O Manager may route IRPs (which the I/O Manager would otherwise send to the device driver objects associated with the underlying device driver object) to the filter driver that owns the device driver object that has attached to the target device driver object. Thus, the I/O Manager hands to the filter driver IRPs aimed at the device driver object the driver is filtering. In this way, access to a file or a cluster of the partition is intercepted.

For further information pertaining to Microsoft Windows NT operating system file related services or any other Microsoft operating system file related services, please refer to the Microsoft Website. It will however, be understood by a person skilled in the art the many ways in which file operations may be intercepted within the many types of commercially available operating system. Therefore, it is considered that no further discussion is required here and that a general overview, as given above, is sufficient for the purposes of carrying out the present invention.

The scan management engine 315 provides core management functions of the prioritization logging program 120 and coordinates the activities of the other components 300, 305,310,320,330. The scan management engine 315 also provides the interface to the virus scanning application 200, for example, as an API, to interact with the virus scan application 200. The scan management engine 315 is further responsible for the starting and the initialization of each of the components 300,305,310,320,330 of the prioritization logging program 120. The scan management engine 315 is further responsible for monitoring and restarting each of the components 300, 305,310,320,330 in the event of failure of any of the components 300, 305,310,320,330 or the data processing system 100.

The scan management engine 315 receives inputs from the virus scanning application 200 detailing the files and directories that the virus scanning application 200 is currently scanning. The virus scanning application 200 sends to the scan management engine 315 a data feed comprising a data string. The data string provides details about which file or directory have or are being scanned. The scan management engine 315 receives the data feed and parses the data string to extract the detail about each individual directory, file or cluster that has, or is, being scanned. The detail about each file may comprise a flag to indicate that the file or directory has been scanned and the date and the time at which the file or directory was scanned. A call is made to the file system map engine 310 to update the file system map with the scan updates identified by the scan management engine 315. The data feed from the virus scanning application 200 may be sent to the scan management engine 315 on completion of the scan or the data feed may be sent as each directory, file or cluster is scanned.

A data feed as received from the virus scanning application 200 may be as follows:

### EXAMPLE 2

Volume C
Volume serial number XYZ
Directory of C:\
<DIR> $user; scanned 16/07/04; 9:00
<DIR> documents; scanned 16/07/04; 9:01
<DIR> accounts; scanned 16/07/04; 9:02
abc.log; scanned 16/07/04; 9:03
def.txt; scanned 16/07/04; 9:04
auto.exe; scanned 16/07/04; 9:05

As can be seen from the example 2, each directory and file is appended with a flag indicating that the directory, file or cluster has been scanned and the date and time that the scan operation took place. For example, <DIR> $user is identified as being scanned on the 16/07/04 at 9:01. The date and time stamp reflect the date and time the directory, file or cluster was scanned.

In another embodiment of the present invention, the virus scanning application 200 may send a data feed comprising the name of each directory, file or cluster that is currently being scanned without providing any date and time stamp data. As the data feed is received by the scan management engine 315, the scan management engine 315, stamps the date and time that the data feed was received. The fact that a data feed was received by the scan management engine 315 is indicative of the fact that each name of a directory, file or cluster in the data feed has been scanned by the virus scanning application 200. The scan management engine 315 determines each of the names of the directories, files and clusters as scanned. The advantage of this embodiment of the present invention is that no modification of the virus scanning application 200 is required.

The update database management component 320 manages a journal of activity updates pertaining to each directory, file or cluster within the identified file system structure. A journal is created at the first initialization of the operation of the prioritization program 120 on the data processing system 100. As the activity of each directory, file or cluster is detected by the file system driver component 330, the detected activity is recorded within the journal. A unique identifier may also be created for each activity record pertaining to a directory, file or cluster and stored along with the activity record. This reduces the size of the journal and the time required to process it during later processing stages.

Referring to Example 3, a journal comprising a set of activity records is shown for a number of directories and files. In the first column is a list of directories and files, which may also include clusters, recorded and obtained from the file system map(s). The first column of the journal comprises the name of the root directory C:\ along with the names of each of the directories and files associated with the C:\ directory. The second column comprises the latest operation performed on the directory, file or cluster. The operation comprises any activity that has taken place within the root directory since the last virus scan. An activity record may comprise a full listing of all activity to the directory, file or cluster or just the last activity to take place on the directory, file or cluster.

The journaling may be aggregated to the directory level, for example, if any activity is determined to take place to a file within a particular directory, the directory maybe flagged as having a write operation. There are several ‘trade off’s within the journal mechanisms with regard to what level of granularity the journal mechanism is deployed. The lower the level of granularity i.e. listing every file and activity record a larger journal is created and searching may be slower, alternatively, the higher the level of granularity the smaller the journal and the quicker the retrieval of the activity records. However, a user may select the level of granularity by a selectable menu function. Lastly, referring to the third column a unique value is written to the journal for each activity record, aiding the retrieval of the activity records.

### EXAMPLE 3

| File path C:\ | Activity | Unique value |
|---|---|---|
| <DIR> $user | Write | #1 |
| <DIR> documents | Create | #2 |
| <DIR> accounts | | #3 |
| abc.log; | delete | #4 |
| def.txt; | write | #5 |
| auto.exe; | write | #6 |

The update database management engine 320 also stores cluster updates where direct access to the disk takes place bypassing updates to the file allocation table (FAT) and other constructs. This captures updates to the file system structure which is not captured by the file system map.

When the scan management engine 315 initiates a scan cycle, the difference engine 300 requests from the update management database the activity records for the file system structure. Upon receiving this instruction, the update management engine 310 creates a new instance of the journal to record all new activities and freezes the current instance of the journal. The frozen journal is not deleted until the scan management engine 315 determines that the virus scan cycle is completed (or is terminated) and a further process is performed to calculate which directories, files or clusters were and were not scanned.

The difference engine 300 performs an analysis operation between the individual entries of the file system map and the individual activity records of the update management database. The difference engine 300 comprises a number of rules for detecting patterns in the activity records for each of the directories, files or clusters.

The analysis step is the first step in the pre-scan preparation and is invoked by the scan management engine 315. The difference engine 300 receives inputs from the scan management engine 315, the update database management component 320 and the file system map engine 310.

The difference engine 300 requests the file system map(s) from the file system map engine 310. The difference engine 300 parses the file system map(s) to identify which directories, files or clusters were scanned at the last scan cycle and which directories, files or clusters were not scanned at the last scan cycle, as shown in Example 4. As described previously, the file system map(s) are updated as data feeds are received by the scan management engine 315. Therefore as shown in Example 4, each directory, file or cluster is assigned a status of scanned or not scanned.

### EXAMPLE 4

| File path | Status |
|---|---|
| <DIR> $user; scanned 16/07/04; 9:00 | Scanned |
| <DIR> documents; | Not scanned |
| <DIR> accounts; scanned 16/07/04; 9:02 | Scanned |
| abc.log; | Not scanned |
| def.txt; | Not scanned |
| auto.exe; | Not scanned |

The difference engine 300 sends a request to the update management engine 310 to request the operation records of each of the directories, files or clusters since the last scan cycle.

The difference engine 300 merges the records of the file system map with the operational records of each directory, file or cluster to create an activity record for each of the components identified as part of the file system structure. This includes merging the records of the cluster map. The difference engine 300 produces a set of activity records which indicate which files are outstanding and require scanning at the next scan cycle.

The difference engine 300 analyses the activity records to determine which directories, files or clusters have been created or deleted since the last scan cycle, which files and/or directories have been accessed since the last scan cycle and which clusters have not been identified as part of the file system structure and have been created or accessed. The resulting output may be as follows:

### EXAMPLE 5

| | | Status/update | |
|---|---|---|---|
| | Status/file | management | |
| File path | system map | database | Outstanding |
| <DIR> $user; | Scanned, | not accessed | No |
| scanned | | | |
| 16/07/04; | | | |
| 9:00 | | | |
| <DIR> | Not scanned, | accessed | Yes |
| documents; | | | |
| <DIR> | Scanned, | not accessed | No |
| accounts; | | | |
| scanned | | | |
| 16/07/04; | | | |
| 9:02 | | | |
| abc.log; | Not scanned | Deleted | No |
| def.txt; | Not scanned | Accessed | Yes |
| auto.exe; | Not scanned | Accessed | Yes |
| Virus.txt | | created | Yes |
| Cluster 123 | | Written/not | Yes |
| | | ID | |

In order to detect a pattern in an activity record, the difference engine 300 comprises a number of rules. For example a rule may state the following:
Rule 1=if entry of file system map=‘scanned’ and if activity record=‘not accessed’: assign status of ‘not outstanding’;
Rule 2=if entry of file system map=‘scanned’ and if activity record=‘accessed’: assign status of ‘outstanding’;
Rule 3=if entry of file system map=‘not scanned’ and if activity record=‘accessed’: assign status of ‘outstanding’;
Rule 4=if entry of file system map=‘not scanned’ and if activity record=‘not accessed’: assign status of ‘not outstanding’;
Rule 5=if entry of file system map=‘empty’ and if activity record=‘created’: assign status of ‘outstanding’;
Rule 6=if entry of file system map=‘not scanned’ and if activity record=‘deleted’: assign status of ‘not outstanding’; and
Rule 7=if entry of file system map=‘empty’ and if activity record=‘cluster and accessed’: assign status of ‘outstanding’.

It will be understood by a person skilled in that art that other rules, above and beyond what has already been described above, are possible without departing from the scope of the invention.

As is shown in the Example 5 and in accordance with Rules 1 to 6, the first column details the name of the file, directory or cluster. This column is as identified in the file system map and/or the cluster map. The second column comprises information pertaining to whether or not the file was scanned during a previous scan cycle. Again this information is taken from the file system map. The third column comprises information about the activity of operations directed towards the file, directory or cluster. This information is received from the update management engine 315. This information informs the difference engine 300 whether the activity was an access operation i.e. a write operation, for example, if no operation took place or a file, directory or cluster was created or deleted. The last column comprises the computation results of the comparison of the second and third columns of data. For example, referring to the second row within the table, the $user directory was scanned at a previous scan cycle and no operations have been detected to the directory (or any of its file contents) since the last virus scan. Hence, the difference engine 300 determines that the directory is not outstanding, because it was scanned at a previous scan and has not been accessed and hence this would indicate that a virus has not embedded itself within the file (Rule 1).

Moving onto to the third row in the table, the directory called document was identified as not scanned at a previous scan cycle, but has been detected as being accessed by an operation since the last scan cycle and therefore is determined by the difference engine 300 as outstanding (Rule 3). As shown by the entry for abc.log, although the file was not scanned it has according to the update management records been deleted, therefore the file abc.log is assigned a status of not outstanding (Rule 6). Finally, moving onto virus.txt and the cluster 123 entry, the virus.txt entry has no data entry in the file system map and therefore the column entry is empty. The absence of an entry indicates that at the time the file system scan was initiated the virus.txt file did not exist within the file system structure. The update management entry column confirms that the virus.txt file has been created since the last scan. Therefore the virus.txt file is assigned a status of outstanding (Rule 5).

Lastly, the column for the cluster 123 entry is empty, which again indicates that no information can be located from the file system map for this entry. Conversely, the entry within the table for the update management database indicates that the cluster 123 has been ‘written to’ since the last virus scan and the write operation to cluster 123 was unable to be mapped to a file within the file system structure. Therefore a status of outstanding is assigned (Rule 7).

The computed data (column 3) from the table is sent to the prioritization engine 315 for processing. The output may be sent as a data string or by other means for passing data between components.

The prioritization engine 305 receives the output from the difference engine 300 and creates a scan list to be sent to the scan management engine 315 for passing onto the virus scanning application 200. The prioritization engine 305 determines which directories, files or clusters should take priority at the next scanning cycle i.e. the directories, files or clusters which should be scanned first at the next scan cycle. The prioritization component 305 comprises one or more rules for determining the priority of each of the directories, files and/or clusters. On receiving the computed data from the difference engine 300, the prioritization engine 315 parses each of the computed data entries and extracts the relevant data for determining the priority order. The prioritization component analysis at least two elements of data, for example, file extension type and computed status, or file extension type, computed status and number of days since being processed by a scan cycle etc.

On extraction of the at least two data elements, the prioritization component 315 matches the at least two data elements to a rule. An example of a rule is as follows:
Rule 8=if file extension type=‘.exe’ and if computed status=‘outstanding’: assign status of ‘High’;
Rule 9=if activity record status=‘outstanding’ and if computed status=‘outstanding’: assign status of ‘High’;
Rule 10=computed status=‘not outstanding’ and if time since last scan=‘>7 days: assign status of ‘Medium’;
Rule 11=computed status=‘not outstanding’ and if activity status=‘not accessed’: assign status of ‘low’; and
Rule 12=computed status=‘not outstanding’ and if activity status=‘not accessed’: assign status of ‘low’, but if time since last scan=‘greater than 10 days’ assign status of ‘medium.

As can be seen with reference to Rules 11 and 12, if it is first determined by the prioritization engine 315 that the prioritization order is ‘low’, the directory, file or cluster will be ranked lower in the priority order within the scan list than a directory, file or cluster with a high priority order. But, at the next scan cycle, if the file, directory or cluster with a low priority order has not been scanned, the prioritization engine will identify this and will rank the file with a higher ranking than determined at a previous scan. Hence, all directory's, file's and cluster's priority order will be propagated up through the priority ranking within the scan list, such that a directory, file or cluster with an initially determined low priority order will over a time period be ranked high such that it will be scanned.

There are many other ways in which the individual entries within the scan list may be prioritized. For example, the individual entries may be prioritized by an order of weightings i.e. files with certain extension types have a higher weighting than others. The weightings may be assigned by requesting the virus definition file from the virus scanning application file to determine which file extensions are more likely to contain a virus.

A user may select-certain types of scans from a selectable menu function. For example, options may be provided to select a ‘fast scan’, which may only scan files that have been modified or created since the last virus scan cycle etc., or a longer scan which scans all files as listed in the prioritized order within the scan list.

To minimize the data entries which are written to the scan list, the prioritization component 305 aggregates the data entries of the scan list to the highest level of directory structure. For example, if the entire contents of the ‘C:\this directory’ structure needs to be scanned, the data entry states ‘C:\this directory’ is what needs to be scanned. Thus, it is not necessary to detail each file located within the ‘C:\this directory’, within the scan list.

Through the creation of the scan list, checkpoints are inserted. As the scan list is processed by the virus scanning application 200, the virus scanning application 200 together with the scan management engine 310 inserts checkpoints. The checkpoints may be a tag or a binary digit which indicates that a particular point has been reached within the scan list. Conversely, the addition of checkpoints within the scan list enable the scan management engine 315 to identify where in the scan list the scan cycle terminated more efficiently than traversing the entire scan list from the start.

The generation of the scan list employs a similar technique to the update management engine 320 and aggregates elements that need to be scanned in the checklist to a higher level rather than detailing every file to be scanned. For example, if all the files below c:\$user needed to be scanned, the one entry of C:\$user will be inserted, along with a file count which is derived from the file system map. If this level of aggregation results in a ratio greater than 1:1000 for the number of files under the aggregated level, the scan management engine 315 may break this ratio down to insert checkpoints at every 1000 files etc.

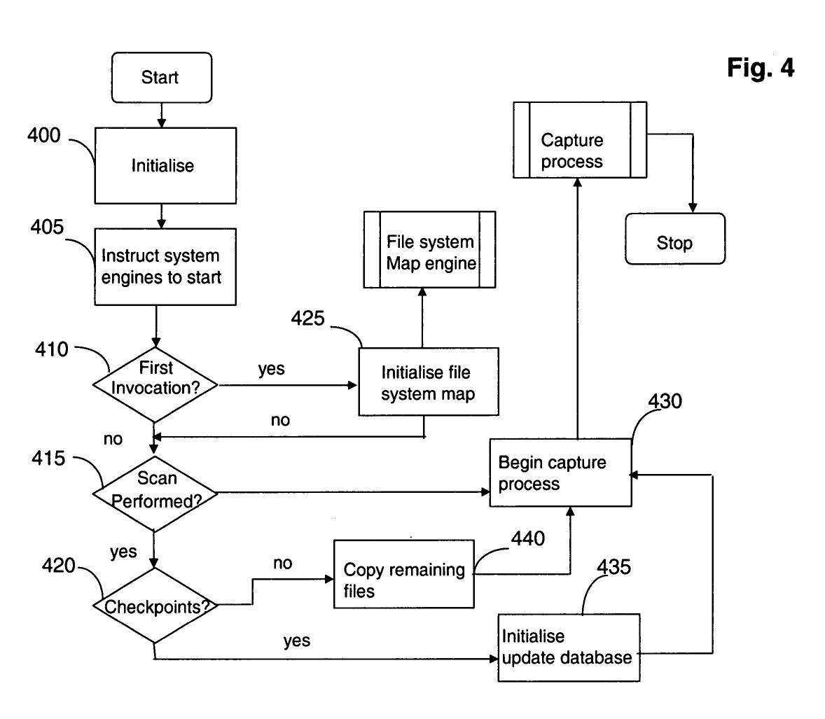

FIGS. 4 to 9 illustrate operational steps of the prioritization logging program 120 and its individual components 300, 305, 310, 315, 325 and 330 in greater detail. Although the operational steps of the prioritization logging program 120 will be explained with reference to the Figures in numerical order, it should be understood by a person skilled in the art, that the operational steps described by the respective Figures may be carried out in any order, without departing from the scope of the invention.

In step 400 (FIG. 4), the scan management engine 315 initializes the file system filter driver program 330, the update database management program 320, the difference engine 300 and the prioritization engine 305. At step 405, each of the aforementioned components is instructed to start. The scan management engine 315 performs a check at decision 410 to determine if this is a first invocation of the scan management engine 315 on the data processing system 100. If the decision is positive, the scan management engine 315 sends a request to the file system map engine 310 to initialize and create a file system map at step 425. In decision step 410, if the determination is negative, control moves to decision 415 and a further determination is made as to whether a virus scan has previously been performed by a virus scanning application 200. If the determination is negative, control moves to step 430 and the file system map engine 310 proceeds to monitor for file system structure updates. Moving back to decision step 415, if the determination is positive, control moves to decision 420 and the scan management engine 315 identifies if all check points within the scan list have been reached.

If the scan management engine 315 determines 420 that all check points have been reached, the scan management engine 315 sends a request to the update database management engine 320 to initialize the update management database, such that it is ready for access and/or retrieval from the individual components of the prioritization logging program 120 at step 435. If at decision 420, a negative determination is made control passes to step 440 and the scan management engine 315 copies the remaining unscanned file information from the update database into the file system map and the files are flagged as outstanding in order to be processed during the next scan cycle. Control passes onto step 430 where the monitoring of the file system structure updates begins.

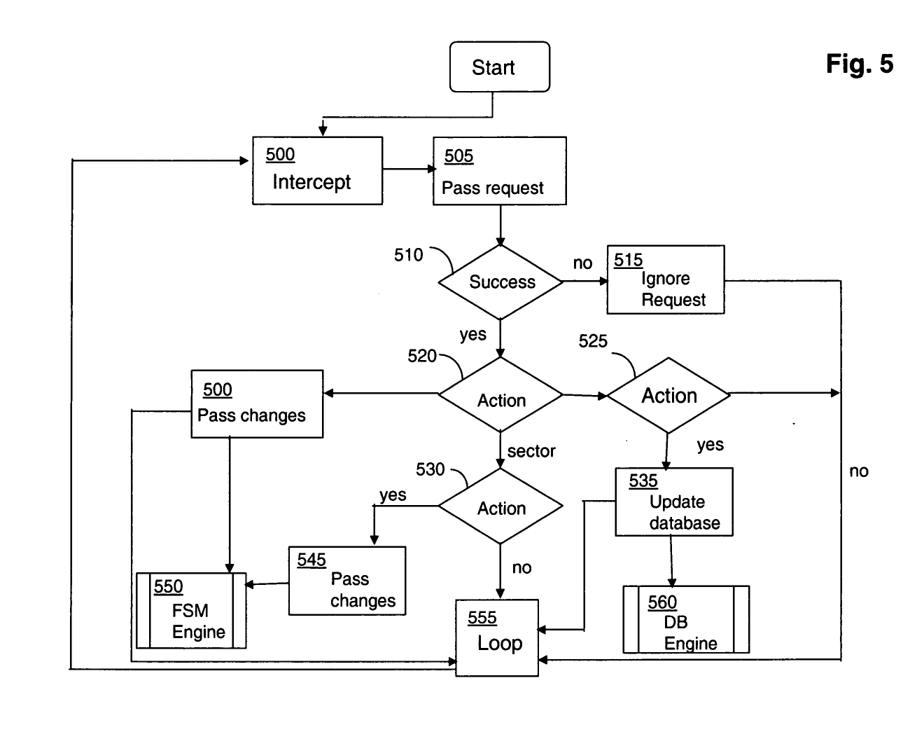

FIG. 5 illustrates the operational steps of capturing of one or more file system updates by the file system filter driver 330. At step 500, the file system filter driver 330 receives a request from step 430 of FIG. 4 to initiate the monitoring of the file system structure. The scan management engine 315 begins by sending a request to the file system filter driver 330 to begin intercepting each input/output request to the file system and/or cluster updates made by an application or directly via the operating system at step 505.

A wait is incurred whilst the file system filter driver 330 waits for a response from the file system driver 220. Once a response is received, a determination 510 is made as to whether step 505 was successful, for example, was a write operation performed to a file within the file system or was the write operation aborted. If a negative response is received, the request is ignored and control passes to step 555, for initiating further I/O intercepts.

If a positive response is determined, control moves to decision 520 and the file system filter driver 330 determines if the action performed at step 500 was an action to a directory, a file or a cluster. If the action performed is an action to a directory or a file, control moves to step 540 and the files system filter driver 330 passes to the file system map engine 310 the update operation performed by the action in order to update the file system map. In parallel with passing the update to the file system map engine 310, step 540 passes control to step 555 to enable the file system filter driver 330 to begin its process steps again.

Moving back to decision 520, if the action performed is determined to be an action performed on a file, control passes to decision 525 and the file system filter driver 330 determines whether the operation performed on the file is an update operation or a create operation. If the operation is an update or a create operation, control passes to step 535 and the update is passed to the update management engine 320.

If at decision 520, the update performed is an update to a cluster, control passes to step 545 and the update operation is requested to be updated on the cluster map by the file system map engine 310. If at decision 520, the update performed is not an update or a create operation, control passes to step 555 for initiating the capture process for further I/O intercepts.

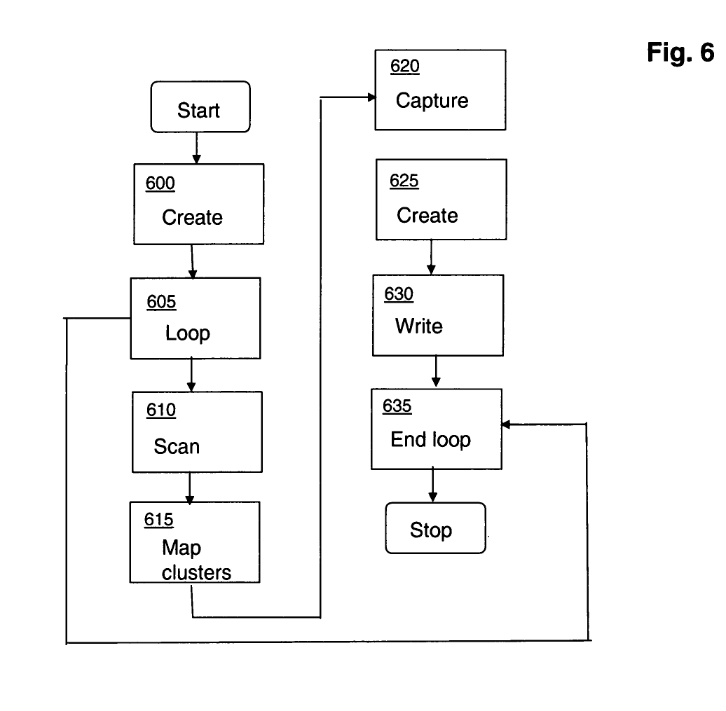

FIG. 6 illustrates file system map engine 310 initialization process. At step 600, the update management database is created and initialized. The process steps of FIG. 6 enter into a loop function at step 605. At step 610, the file system map engine 310 scans all of the volumes located within the data processing system 100 or other designated disk drives, or alternatively, only those volumes selected by a user of the data processing system 100. As the designated volume is scanned, the file system map engines 310 creates a map of the clusters and their association with files in the file system at step 615. The file system map engine 310 also creates a file system map detailing the file system structure of each disk volume selected by the user at step 620.

As each of the directories, files, or clusters are captured by the file system map engine 310, the file system map engine 310 creates a unique value for each file path at step 625 to aid retrieval and lookup. Each record is written to the file system map by the file system map engine at step 630. At step 635, the loop is suspended whilst the remainder of the file system structure is scanned.

Once the file system map engine 310 is initialized and the file system map is created, the file system map engine 310 continually updates the file system map and the cluster map in response to updates being detected in the data processing system 100.

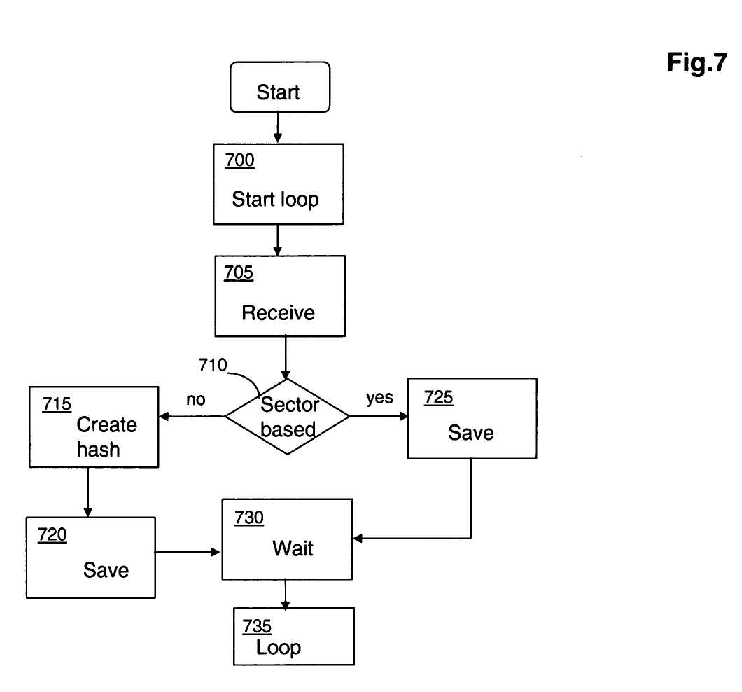

For example, referring to step 700 of FIG. 7, a loop in the process beings to continually respond to updates received by the file system map engine at step 705 from the file system filter driver 330. When the file system map engine 310 receives an update from the file system filter driver 330, control moves to decision 710 and the file system map engine 310 determines whether the update to the file system is a cluster update. If the response is positive, control moves to step 725 and the file system map engine 310 determines the update made to the specific cluster and saves the update to the cluster map. Control then moves to step 730 and a wait action is performed until the next update is received by the file system map engine 330. On receiving the next update, control moves to step 735 and the process steps of FIG. 7 begin at step 705. Moving back to decision 710, if the determination is negative and the update to the file system is not cluster based, control passes to step 715 and the file system map engine 310 creates a unique hash value entry in the update management database at step 720. Control passes to step 730 and the file system map engine 310 waits for the next file system structure update to be received.

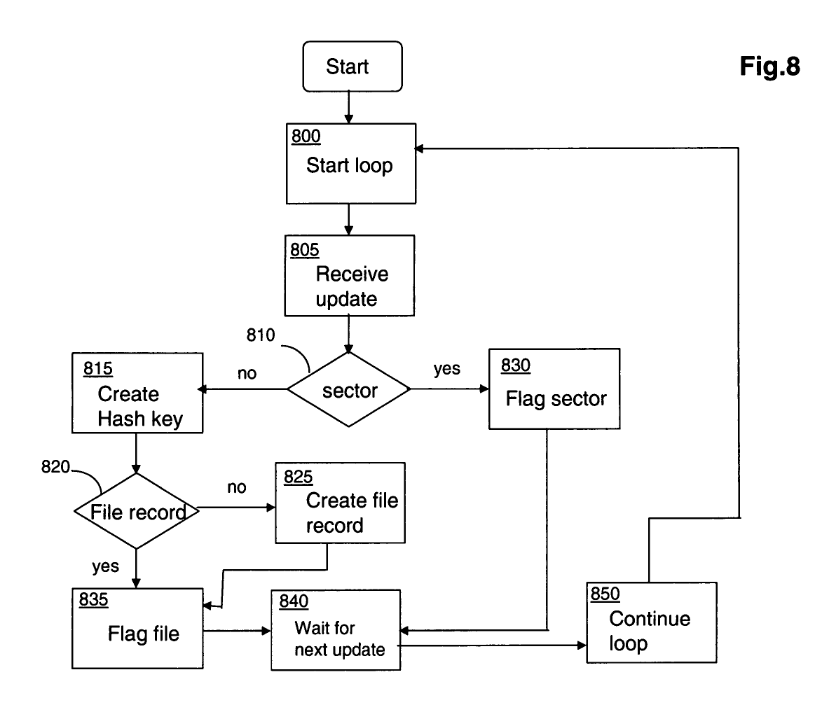

Referring to FIG. 8, the process steps of the file system map engine 310 are described whilst a virus scan is in operation. Again, as with FIGS. 6 and 7, the file system map engine 310 enters into a loop function at step 800 to ensure the continued operation of receiving information updates from the scan management engine 315 whilst a virus scan cycle is in progress. For example, the information details the date and time that the scan cycle took place for each directory, file or cluster scanned by the virus scanning application 200.

With reference to step 805, a data feed is received from the scan management engine 315 at step 805. The scan management engine 315 parses the data feed to determine 810 the name of the file, directory or cluster that has been scanned and the date and time this took place. The file system map engine 310 identifies if a cluster has been scanned, opposed to a file or a directory. If a positive determination is made, the file system map engine 310 flags the update of the cluster as scanned at step 830 in the cluster map. Control passes to step 840 and the file system map engine 310 enters into a wait state until a further update is received from the file system filter driver 330. Moving back to the determination 810, if the determination is negative, control moves to step 815 and the file system map engine 310 creates a unique value for the file or directory update as identified by the file system driver 330 and stored in the update management database with an assigned status of scanned. The file system map engine 310 makes a further determination 820, to determine if the file record already exists in the file system map. If a negative determination is made, control moves to step 825 and a record of the file is created in the update database and the file is flagged as scanned at step 835. Control then moves to step 840 and the file system map engine 310 enters a wait state until the next update is received.

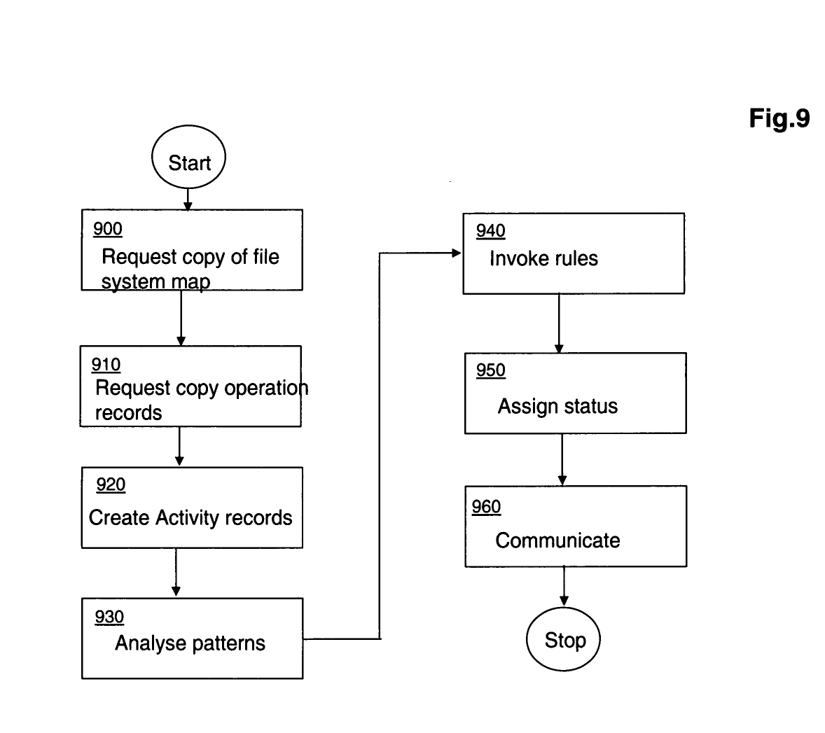

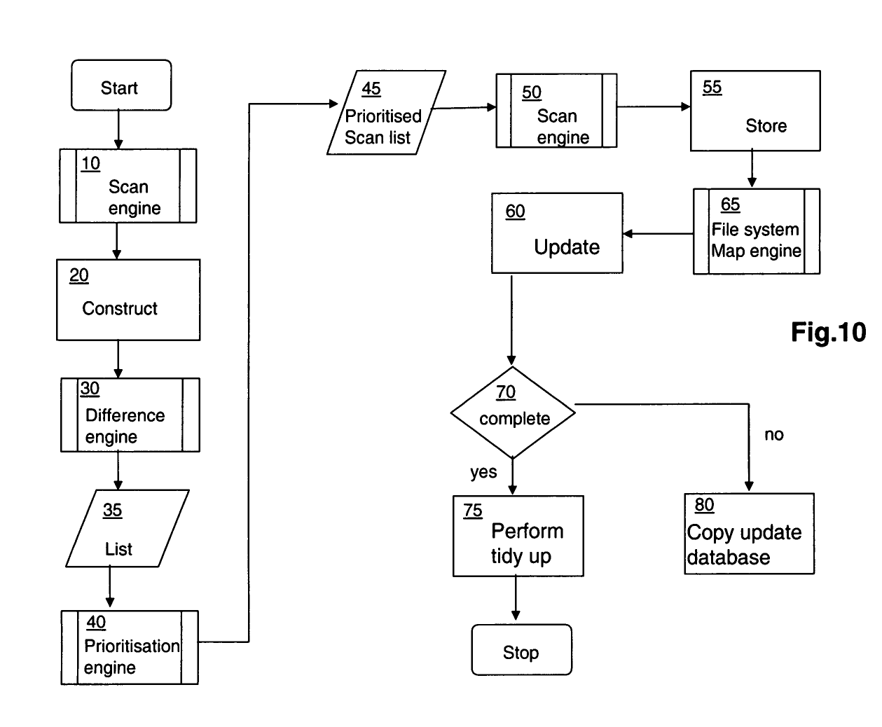

Now that each of the components and the various operational steps have been explained, FIG. 10 (with reference to FIG. 9) details the process steps of the each of the components of the invention and how they interact with each other.

The scan management engine 315 at step 10 initiates a scan of one or more designated disk drives. The virus scanning application 200 communicates a data feed comprising the names of each of the directories, files or clusters that have been scanned or are being scanned. Upon receiving the data feed, the scan management engine 315 parses the data feed and extracts the individual entries pertaining to the directories, files and clusters that have been scanned. As the individual entries are parsed, the scan management engine 315 date stamps and time stamps each of the individual entries. The date and time stamped entries are communicated to the file system map engine 310 for updating in the file system map at step 20. Once the scan management engine 315 communicates to the difference engine 300 that the scan cycle has completed, the difference engine 300 requests a copy of the file system map from the file system map engine 310 and a copy of the activity records from the update management engine 320. At this point, the update management database is frozen for onward processing, and a new instance is created to enable new changes to the file system structure to be captured whilst the scan cycle proceeds.

At step 30 and with reference to FIG. 9, the difference engine 300, requests a copy of the file system map and the operation records, as stored in the update management database, at step 900 and 910. The difference engine 300 merges the entries of the file system map with the operation records, at step 920. The difference engine 300 then proceeds to analyze the entries of the file system map with the activity records of the update management database. The difference engine 300 looks for patterns within the merged data to determine which files, directories or clusters have been, for example, scanned and accessed, scanned and not accessed, not scanned and not accessed, not scanned and accessed and files, at step 930. The difference engine 300 also identifies which directories and clusters have been created or deleted since the previous scan cycle, at step 930. Once the patterns within the merged data are detected, a number of rules are invoked to determine and assign a status to each of the activity record, at step 940. Once an overall status has been assigned to each of the records, the difference engine 300 creates a scan list detailing each of the directories, files and/or clusters as identified by the file system map, cluster map and the update management database along with the computed status of each directory, file or cluster at step 960 (and step 35 of FIG. 10).

The list is communicated to the prioritization engine 305 and the prioritization engine 305 determines the priority of each of the entries within the list received, at step 40. The output of this process is a scan list detailing a priority order for each of the directories, files or clusters to be scanned at the next scan cycle (step 45).

In addition to the priority order of directories, files or clusters to be scanned, the priority order of each of the entries may be affected by a number of weightings. For example, a particular file extension may take a higher priority that another type of file extension owing to information communicated from a virus definition file.

Once created, the prioritized scan list is communicated to the scan management engine 315 at step 45 and step 55 which in turn communicates the scan list to the virus scanning application 200. The virus scanning application 200 performs a scan cycle, scanning the directories, files or clusters as itemized in the prioritized order in the scan list. The scan management engine 315 and the virus scanning application 200 are responsive to each other in order to manage the checkpoints with the scan list. For example, if the scan terminated at a particular checkpoint the virus scanning application 200 communicates the checkpoint information to the scan management engine 315. As the virus scanning application 200 is performing a scan cycle, a data feed is communicated to the scan management engine 315 to inform the scan management engine 315 which directories, files and/or clusters have or are being scanned along with any checkpoints that have been reached. The scan management engine 315 parses the data feed extracting the data pertaining to the files, directories or clusters that are being scanned and creates a time and date stamp for each of the entries within the data feed. The time stamped data is communicated to the file system map engine 310 for updating the file system map with the newly received scan information at step 55 and 60.

At step 65, the checkpoints are updated within the prioritized scan list to reflect the new scan. This is particularly important if a scan cycle was terminated. A determination 70 is performed to determine whether the scan cycle completed and all of the checkpoints with the prioritized scan list have also been completed. If a positive determination is made, control passes to step 75 and several ‘housekeeping’ operations are performed on the file system map, the cluster map and the update database. If a negative determination is made, for example certain checkpoints are not reached because a scan was terminated, control passes to step 80 and the activity records of the update database are copied to the file system map. The directories, files or clusters which were not scanned are flagged as outstanding in the file system map. The working copy of the update database is then removed once the changes to the file system map are complete.

With reference to step 75, to clarify further, the housekeeping operations may comprise resetting the contents of the file system map(s) and the update management database to reflect that there are no outstanding directories, files or clusters to be scanned. For the file system map, this may result in the removal of all specific directories and file entries leaving just the file system structure information. For the cluster map, this will result in the resetting of the status of clusters to a ‘clear’ status, and removal of the working copy of the update database used as input into the scan process.

Programs 120 and 200 can be loaded into computer 100 from a computer readable medium such as magnetic disk or tape, optical CD, DVD, etc. or the Internet and a TCP/IP adapter card 119.

Although the invention has been described with reference to a virus scanning application, it will be appreciated by a person skilled in the art that the invention is equally applicable to other environments where a prioritization system would be of benefit, for example, a content management system.

What is claimed is:

1. A method for scanning files for a virus, said method comprising the steps of:
identifying a multiplicity of files which have been accessed since a previous virus scan; and
based on the identifications of said multiplicity of files which have been accessed since a previous virus scan, scanning for viruses said multiplicity of files, and not scanning for viruses other files which have not been accessed since said previous virus scan.

2. A method as set forth in claim 1 wherein:
the step of scanning said multiplicity of files for viruses is performed by scanning said multiplicity of files in a priority order; and
said priority order is based on a type of extension of said multiplicity of files.

3. A method as set forth in claim 2 wherein an .exe type of file has higher priority than files with other types of extensions.

4. A method as set forth in claim 1 wherein:
the step of scanning said multiplicity of files for viruses is performed by scanning said multiplicity of files in a priority order; and
said priority order is based on a duration of an elapsed time since said files of said multiplicity were accessed and not scanned for viruses.

5. A method as set forth in claim 1 wherein:
the step of scanning said multiplicity of files for viruses is performed by scanning said multiplicity of files in a priority order; and
said priority order is based in part on whether said files of said multiplicity were scanned for viruses during a previous scan cycle.

6. A method as set forth in claim 1 wherein in response to requests to update said files, further comprising preliminary steps of making records indicating which files have been updated and when said files were updated.

7. A method as set forth in claim 1 wherein said multiplicity of files which have been accessed have been updated.

8. A system for scanning files for a virus, said system comprising:
means for identifying a multiplicity of files which have been accessed since a previous virus scan; and
means, based on the identifications of said multiplicity of files which have been accessed since a previous virus scan, for scanning for viruses said multiplicity of files, and not scanning for viruses other files which have not been accessed since said previous virus scan.

9. A system as set forth in claim 8 wherein:
said means for scanning said multiplicity of files for viruses comprises means for scanning said multiplicity of files in a priority order; and
said priority order is based on a type of extension of said multiplicity of files.

10. A system as set forth in claim 9 wherein an .exe type of file has higher priority than files with other types of extensions.

11. A system as set forth in claim 8 wherein:
said means for scanning said multiplicity of files for viruses comprises means for scanning said multiplicity of files in a priority order; and
said priority order is based on a duration of an elapsed time since said files of said multiplicity were accessed and not scanned for viruses.

12. A system as set forth in claim 8 wherein:
said means for scanning said multiplicity of files for viruses comprises means for scanning said multiplicity of files in a priority order; and
said priority order is based in part on whether said files of said multiplicity were scanned for viruses during a previous scan cycle.

13. A system as set forth in claim 8 further comprising, means responsive to requests to update said files, for making records indicating which files have been updated and when said files were updated.

14. A system as set forth in claim 8 wherein said multiplicity of files which have been accessed have been updated.

15. A computer program product for scanning files for a virus, said computer program product comprising:
a computer readable medium;
first program instructions to identify a multiplicity of files which have been accessed since a previous virus scan; and
second program instructions, based on the identifications of said multiplicity of files which have been accessed since a previous virus scan, to scan for viruses said multiplicity of files, and not scan for viruses other files which have not been accessed since said previous virus scan; and wherein
said first and second program instructions are stored on said medium.

16. A computer program product as set forth in claim 15 wherein:
said second program instructions scan said multiplicity of files for viruses by scanning said multiplicity of files in a priority order; and
said priority order is based on a type of extension of said multiplicity of files.

17. A computer program product as set forth in claim 16 wherein an .exe type of file has higher priority than files with other types of extensions.

18. A computer program product as set forth in claim 15 wherein:
said second program instructions scan said multiplicity of files for viruses by scanning said multiplicity of files in a priority order; and
said priority order is based on a duration of an elapsed time since said files of said multiplicity were accessed and not scanned for viruses.

19. A computer program product as set forth in claim 15 further comprising third program instructions, responsive to requests to update said files, to make records indicating which files have been updated and when said files were updated; and wherein said third program instructions are stored on said medium.

20. A computer program product as set forth in claim 15 wherein said multiplicity of files which have been accessed have been updated.
